(19) United States
(12) Patent Application Publication
(10) Pub. No.: US 2006/0272843 A1
(43) Pub. Date: Dec. 7, 2006

(54) ELECTRIC CONNECTION ELEMENT

(75) Inventors: PETER BERGHOFER, Mullendorf (AT); Josef Sugetich, Trausdorf (AT); Mathias Pedevilla, Wien (AT)

Correspondence Address: Henry M. Feiereisen;Henry M. Feiereisen, LLC, Suite 4714, 350 Fifth Avenue, New York, NY, 10118, US

(73) Assignee: Outokumpu Copper Neumayer GmbH, Leobersdorf (AT)

(21) Appl. No.: 11/420,920

(22) Filed: May 30, 2006

Related U.S. Application Data
(60) Provisional application No. 60/686,185, filed on Jun. 1, 2005.

(30) Foreign Application Priority Data
Jun. 1, 2005 (AT) A 939/2005

(51) Int. Cl. H01R 4/18

(52) U.S. Cl. 174/94 R

(57) ABSTRACT

An electric connection element includes an electric conductor, and an electrically conductive coating which is applied onto the conductor and has, at least in regions thereof, a structuring and/or rough surface. As a result, the connection element can easily be handled and the coating can be quickly heated.

### CROSS-REFERENCES TO RELATED APPLICATIONS

This application claims the benefit of prior filed U.S. provisional Application No. 60/686,185, filed Jun. 1, 2005, pursuant to 35 U.S.C. 119(e), the content of which is incorporated herein by reference.

This application also claims the priority of Austrian Patent Application, Serial No. A 939/2005, filed Jun. 1, 2005 pursuant to 35 U.S.C. 119(a)-(d), the content of which is incorporated herein by reference.

### BACKGROUND OF THE INVENTION

The present invention relates, in general, to an electric connection element for connecting electric components.

Connection elements of a type involved here have been used to electrically interconnect several electric components, e.g. solar cells, and are constructed in the form of a flat wire as electric conductor which has a coating of solder material. As the connection element is heated to melt the coating, it is soldered with the electric component. Coated connection elements designed as punched parts or cut bands have also been known.

Common to all conventional connection elements is the drawback that significant energy amounts are required to heat up the coating fast enough. As a result, the coating cannot be quickly heated up sufficiently so that a reliable connection between an electric conductor and the electric component is not ensured. In addition, conventional connection elements, including those configured as flat wire, have a coating that normally has a convex surface configuration.

It would therefore be desirable and advantageous to provide an improved connection element to obviate prior art shortcomings and to realize a reliable bond between an electric conductor and electric components while enabling higher process speeds.

### SUMMARY OF THE INVENTION

According to one aspect of the present invention, an electric connection element includes an electric conductor, and an electrically conductive coating applied on the electric conductor and having a surface configured, at least in regions thereof, with a surface enlargement,

The enlargement may hereby be realized by pattering or structuring the surface of the coating and/or roughening the surface of the coating. The terms “pattering” and “structuring” are hereby used interchangeably to refer to a modification of the coating surface. In the following description, the term “structuring” is used only for the sake of simplicity.

The present invention resolves prior art problems by enlarging the surface area of the coating to effect increased light and/or heat absorption. Heat required for a soldering or bonding process can thus be introduced easier and faster. Currently preferred is the formation of the surface enlargement as integral part of the coating. In other words, the coating material itself is modified in a way to realize an enlarged surface area, without adding foreign matter.

According to another feature of the present invention, the coating may be made of homogenous material which is surface-treated to provide the surface enlargement, i.e. structured and/or roughened surface. The homogeneity ensures an even heating of the entire coating which is thus available in its entirety for a subsequent bonding process.

According to another feature of the present invention, the electrically conductive coating may contain a solderable material, for example a solder, such as tin. As a consequence, the coating itself can ensure the implementation of a firmly adhering soldered connection in one process step.

According to another feature of the present invention, the electrically conductive coating may contain an adhesive, e.g. a conductive adhesive. In this way, the coating may effect the implementation of a firmly adhering adhesive bond.

According to another feature of the present invention, the electric conductor may be made of metal, such as copper, or metal alloy, such as a copper alloy. This realizes an especially high electric conductivity as well easy handling capability.

According to another feature of the present invention, the structuring and/or rough surface may include a knurling or fluting. Such a surface modification can for example be made especially easily and automatically through rolling.

According to another feature of the present invention, the structuring and/or rough surface may be made through grinding. In this way, the coating can be provided with properties which are independent on the treatment direction and is thus the same on the surface in all directions.

According to another feature of the present invention, the structuring and/or rough surface may be made through etching. This chemical treatment also allows realization of an even surface modification.

According to another feature of the present invention, the structuring and/or rough surface may extend in cross section only across a coating region that is intended for energy absorption. Thus, it is not required to treat the entire surface of the coating. Only the one surface region has to be modified which is irradiated later, for example with infrared light, for attachment of the connection element onto the electric component through heating.

According to another feature of the present invention, the structuring and/or rough surface may extend in cross section over the entire circumference of the electric conductor. When using the connection element according to the invention, this configuration does not require consideration as to which part of the coating should be provided with a modified surface. The process steps are simplified accordingly.

According to another feature of the present invention, the electric conductor may be made from a punched part or a cut band. As a result, the connection element is especially easy to make and is cost-efficient.

According to another feature of the present invention, the electric conductor may have a length dimension which is greater than a cross section thereof and may be configured in the form of a wire for example. In this way, it is possible to interconnect many electric components by a connection element in one process step.

According to another feature of the present invention, a knurling or fluting may extend in substantial parallel relationship to the length dimension of the electric conductor. This has the advantage that the fluting or knurling can easily be applied continuously during production of the connection element. Moreover, it is especially advantageous that a surface is realized which is uniform across the length dimension and the coating thus exhibits also uniform properties.

According to another feature of the present invention, a grinding direction may extend in substantial parallel relationship to the length dimension of the electric conductor. Also in this case, the surface treatment can be carried out easily in a continuous process. Thus, a surface can be realized which is also uniform across the length dimension and a coating which exhibits also uniform properties.

According to another feature of the present invention, the electric conductor can be circular in cross section. This allows the use of commercial wires.

According to another feature of the present invention, the electric conductor may have a configuration which deviates from a circular shape in cross section, for example a rectangular shape, and may be designed as flat wire. As a consequence of the greater contact surface, an especially good bond of the connection element upon the electric component is realized. Moreover, the available area of the coating increases, allowing easier heat input.

According to another feature of the present invention, the surface of the coating may be provided over the entire length of the connection element with a structuring and/or rough surface. This allows an especially high heat input as well as an especially simple production and handling. The structuring and/or rough surface can be applied continuously during production while positively ensuring that the coating has in each area the same properties.

According to another feature of the present invention, the coating may extend over the entire length of the connection element. It is hereby of advantage that there is no need during fabrication to take into account the areas where the coating is located, and moreover a surface protection for the electric conductor is realized.

According to another aspect of the present invention, the connection element may be applied on a solar cell. The implementation of a reliable connection between solar cell and electric conductor is especially important, when used in this way, so that the application of a structuring and/or rough surface in accordance with the invention is of particular advantage.

According to another feature of the present invention, at least two solar cells may be interconnected by a connection element according to the invention. Connection elements according to the invention can thus be used to interconnect several solar cells to thereby form a greater assembly, for example a solar module. The solar module may hereby be encapsulated to be weather-proof.

According to yet another aspect of the present invention, a method of contacting electric components, in particular solar cells, includes the steps of coating an electric conductor with an electrically conductive coating, enlarging a surface area of the coating, thereby producing an electric connection element, and placing the electric connection element onto an electric component with the enlarged surface area facing the electric component to thereby enable the coating to establish a firm connection between the electric conductor and the electric component.

As a result, the connection between the electric conductor and the electric component can be established especially quickly while consuming comparably little amounts of energy.

According to another feature of the present invention, the surface enlargement may be realized by providing the coating surface with a structuring and/or roughening the surface of the coating.

According to another feature of the present invention, an electric conductor may hereby be used having a great length dimension in comparison to the cross section and can be configured, for example, as wire, preferably as flat wire. The electric conductor may suitably be applied along its length dimension onto the electric component. This allows a connection element to interconnect many electric components in one process step.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1a is a schematic perspective view of a first embodiment of a connection element according to the present invention;

FIG. 1b is cross sectional view of the connection element;

FIG. 2a is a schematic perspective view of a second embodiment of a connection element according to the present invention;

FIG. 2b is cross sectional view of the connection element of FIG. 2a;

FIG. 3a is a schematic perspective view of a third embodiment of a connection element according to the present invention;

FIG. 3b is cross sectional view of the connection element of FIG. 3a;

FIG. 4 is a schematic perspective view of a fourth embodiment of a connection element according to the present invention;

FIG. 5a is a schematic sectional view of a process step for attaching an electric connection element according to the invention onto an electric component;

FIG. 5b is a schematic sectional view of the connection element attached to the electric component;

FIG. 6 is a schematic perspective view of a fifth embodiment of a connection element according to the present invention;

FIG. 7 is a schematic perspective view of a solar cell with two electric connection elements according to the invention attached thereon,

FIG. 8 is a schematic perspective view of a solar module comprised of a plurality of solar cells interconnected by means of electric connection elements according to the invention; and

FIG. 9 is a detailed view of an area marked A in FIG. 8 to show the solar module with two solar cells interconnected by means of electric connection elements according to the invention.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

This is one of two applications both filed on the same day. Both applications deal with related inventions. They are commonly owned and have the same inventive entity. Both applications are unique, but incorporate the other by reference. Accordingly, the following U.S. patent application, based on U.S. provisional Application No. 60/686,184, filed Jun. 1, 2005, entitled “ELECTRIC CONNECTION ELEMENT” is hereby expressly incorporated by reference.

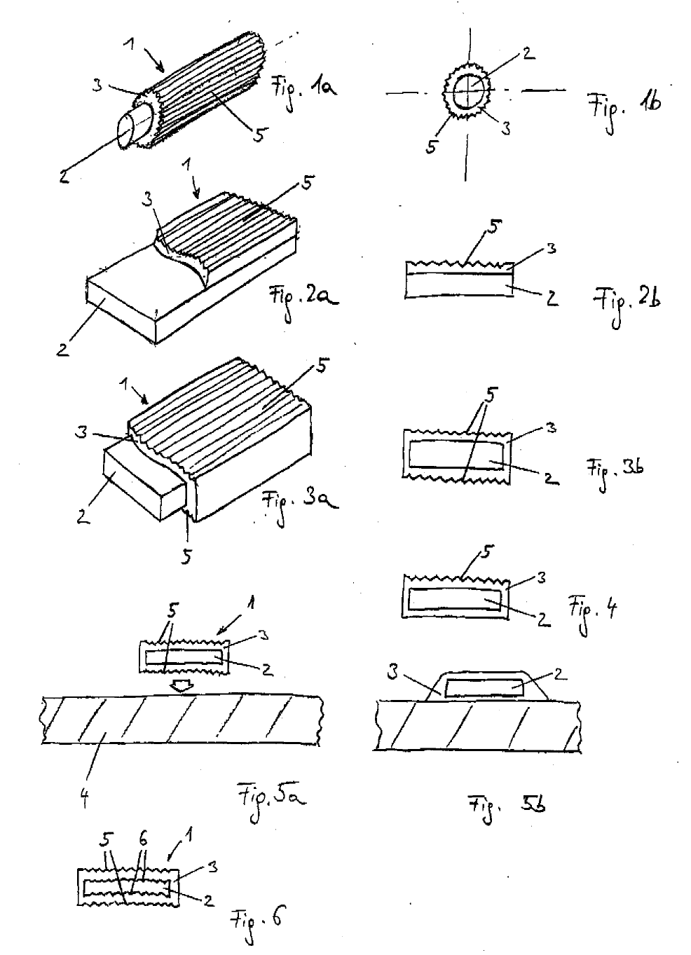

Turning now to the drawing, and in particular to FIGS. 1a, 1b, there is shown an electric connection element, generally designated by reference numeral 1 and including an electric conductor 2 which is substantially circular in shape and forms a core member. The electric conductor 2 is provided all-round with an electrically conductive coating 3 which may be made of homogenous material and contain a solder material, e.g. a solder such as tin. As an alternative, the coating 3 may also contain an adhesive, e.g. a conductive adhesive. The coating 3 is surface-treated to provide a surface enlargement in the form of a structuring and/or rough surface 5. Surface treatment may involve rolling, grinding, etching or the like process. In other words, the coating material itself is modified in a way to realize an enlarged surface area, without adding foreign matter The effective surface area of the coating 3 is thus increased compared to a coating which has not been modified or surface-treated.

FIGS. 2a, 2b show a second embodiment of an electric connection element 1. Parts corresponding with those in FIG. 1a are denoted by identical reference numerals and not explained again. The description below will center on the differences between the embodiments. In this embodiment, the electric conductor 2 of the electric connection element 1 is designed as flat wire so as to have a cross section which non-circular and essentially rectangular in shape. The electric conductor 2 has an upper side which is provided with an electrically conductive coating 3 having an outer side which is provided with a surface enlargement, i.e. structuring and/or rough surface 5. As an alternative or in addition, it is of course also conceivable to provide the lower side of the electric conductor 2 with a coating.

FIGS. 3a, 3b show a variation of the electric connection element 1 of FIGS. 2a, 2b. Parts corresponding with those in FIG. 2a are again denoted by identical reference numerals and not explained again. The description below will center on the differences between the embodiments. In this embodiment, both the top and bottom sides of the electric connection element 1 are provided with the coating 3 which has been surface-treated to provide a structuring and/or rough surface 5. As the coating 3 is applied in cross section over the entire circumference of the electric conductor 2, the electric connection element 1 becomes universally applicable. During production, there is no longer a need to take into account the correct position of the electric connection element 1. In addition, the electric connection element 1 is protected against harmful environmental impacts and corrosion. There is no need however to apply the coating 3 everywhere of even thickness. Rather, more coating material may be applied on one side of the connection element 1. On the opposite side, a layer thickness of the coating 3 may be reduced. Suitably, the layer thickness is greater on the side intended for contacting than on the opposite side where the coating assumes primarily a protective function.

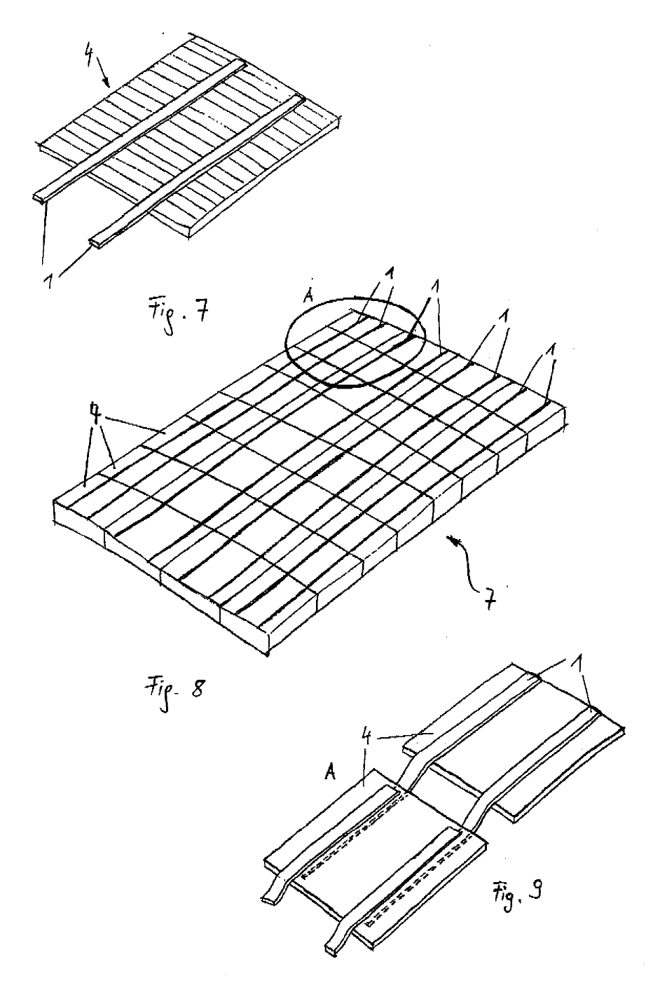

FIG. 4 shows another variation of an electric connection element 1 of FIGS. 2b, 3b. Parts corresponding with those in FIG. 3b are denoted by identical reference numerals and not explained again. The description below will center on the differences between the embodiments. In this embodiment, the electric conductor 2 of the electric connection element 1 is designed as flat wire which is coated by the electrically conductive coating 3, whereby the coating 3 is surface-treated to provide the structuring and/or rough surface 5 on only the side of the electric conductor 2 which is intended for energy absorption. While the structuring and/or rough surface 5 extends thus in cross section only across a section of the circumference of the coating 3, the coating 3 as such is applied over the entire circumference so that the electric conductor 2 is completely enveloped by the coating 3. As a consequence, the electric conductor 2 can be protected against environmental impacts and corrosion at the same time. Also in this case, there is no need to apply the coating everywhere of even thickness. Rather, more coating material may be applied on one side for example. On the opposite side, the layer thickness is reduced for example. In an especially advantageous manner, the layer thickness is greater on the side intended for contacting than on the opposite side where the coating assumes primarily a protective function.

Referring now to FIG. 6, there is shown a schematic perspective view of yet another embodiment of a connection element 1 according to the present invention. Corresponding parts are again denoted by identical reference numerals and not explained again. The description below will center on the differences between the embodiments. In this embodiment, the electric conductor 2 of the electric connection element 1 has a surface 6 which is also surface-treated in addition to the surface-treatment of the coating 3 to provide the structuring and/or rough surface, so that the electric conductor 2 is also provided with a structured and/or roughened surface 6. This is advantageous because a greater contact surface is available between electric conductor 2 and the coating material so that the attainable adhesive force is increased. At the same time, the layer thickness of the coating can be reduced to attain a predefined adhesive force.

The use of an electric connection element according to the invention will now be described in more detail with reference to FIGS. 5a and 5b. The electric connection element 1, shown here by way of example has a configuration as shown in FIG. 3b, and is comprised of the electric conductor 2, designed as flat wire, and the coating 3 which is applied all-round of the conductor 2 and is surface-treated on opposite broad sides of the conductor 2 to provide a structuring and/or rough surface 5. The connecting element 1 is to be attached to an electric component 4, a solar cell for example, in such a manner that the coating 3 is disposed with a broadside in the direction of an energy input apparatus. The energy input apparatus may involve any type of apparatus which is suitable to sufficiently heat the coating material for implementation of a reliable connection. An example may include in particular an infrared device. As the coating 3 has a structuring and/or rough surface 5 on both broadsides of the connection element 1, the connection element 1 can be applied in the depicted disposition as well as also in a 180° rotated position. When made of solderable material, the coating 3 may be heated by infrared light for example and melted. As a result, it bonds with the electric component 4 and ensures a connection between electric conductor 2 and electric component 4 after cooling down.

In all embodiments, the structuring and/or surface 5 of the coating 3 can have any kind of structuring, e.g. grooves in longitudinal and/or transverse direction, flutes in longitudinal and/or transverse direction, grinding marks in longitudinal and/or transverse direction, or the like. The structuring and/or rough surface 5 may have one or more preferred directions or may be configured the same in all directions. The structuring and/or rough surface 5 may be implemented mechanically and/or chemically, e.g. by etching or grinding.

In all embodiments, the coating 3 may itself represent a means for connection of electric conductor 2 and electric component 4. No further connection means such as for example solder or adhesive is then necessary when using the electric connection element 1.

The coating 3 may be made of a solderable material. The increase in surface through the incorporation of a structuring and/or roughing of the surface of the coating 3 enables a quicker heating for formation of a soldered bond between electric conductor 2 and electric component 4. Such soldering may be carried out automatically. Soldering may be executed by means of infrared light. As the coating 3 is made of solderable material, in particular a solder, e.g. tin, soldering may be carried out without added material. In this case, the solder necessary for a soldered bond is the coating material itself.

As an alternative, the electrically conductive coating 3 may contain an adhesive to effect the connection between the electric conductor 2 and the electric component 4. Also in this case, the increase in surface through the incorporation of a structuring and/or roughing of the surface of the coating 3 results in an improved energy input into the coating 3 and thus a quicker and reliable realization of an adhesive bond between the electric conductor 2 and the electric component 4.

Regardless of the construction of the connection element 1 according to the present invention, the surface treatment of the coating results in a flat and planar surface configuration. Thus, the electric connection element 1 is absolutely flat and planar at least in the areas of surface treatment. This is advantageous, when attaching the connection element 1 onto an electric component 4, such as solar cell, because the connection element 1 rests flatly on the electric component 4 and thereby enables the implementation of a secure and reliable bond. When soldered onto a solar cell, in particular on an imprinted silver bus bar providing a counter contact in the soldered bond, the material extends absolutely flat, leading to significant enhancement of the soldering results. In addition, the connection element 1 according to the present invention has a substantially flat and planar coating surface so that the connection element 1 is much easier to manipulate. In particular when using typical vacuum grippers, such planar objects can be grabbed securely and quickly. Moreover, a wire with planar, flat surface can also be wound onto a coil in a more space-saving and faster manner and with enhanced process safety. The wire, in particular a flat wire, is thus easy to wind onto a coil in layers and easy to unwind. The straight configuration is hereby retained which could conceivably be impaired when the winding is executed in irregular manner. As a result, automation is easier to implement and costs can be decreased.

An electric connection element 1 according to the invention is especially applicable as connector for a solar cell 4. As shown in FIG. 7, two electric connection elements 1, respectively designed as flat wire for example, are applied on a surface of the solar cell 4. As an alternative, other described connection elements according to the invention may, of course, be used as well. Using connection elements 1 with an electric conductor 2 that has also a structured and/or roughened surface 5, as connector for a solar cell 4, results in a high strip-off force or tear-off force required to remove the connection element 1 from the solar cell. It is also possible to reduce the coating thickness when the strip-off force or tear-off force is predefined.

Several solar cells 4 may be interconnected in any suitable fashion to form a solar module 7 by means of the electric connection elements 1. When the connection elements 1 are designed as flat wire, continuous connection bands as shown in FIG. 8 are realized. As an alternative, other described connection elements according to the invention may be used, whereby continuous connection bands are not visible when the connection is realized using punched parts or cut bands for example.

A possibility to connect two adjacent solar cells 4 of a solar module 7 is shown in FIG. 9. Each top surface of a solar cell 4 is hereby connected with the bottom side of an adjacent solar cell 4 by connection elements 1 according to the invention.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. An electric connection element, comprising:
an electric conductor; and
an electrically conductive coating applied on the electric conductor and having a surface configured, at least in regions thereof, with a surface enlargement.

2. The electric connection element of claim 1, wherein the surface enlargement is implemented by structuring the surface and/or roughening the surface.

3. The electric connection element of claim 1, wherein the surface enlargement is an integral part of the coating.

4. The electric connection element of claim 1, wherein the coating is made of homogenous material which is surface-treated to provide the surface enlargement.

5. The electric connection element of claim 1, wherein the electrically conductive coating contains a solderable material.

6. The electric connection element of claim 5, wherein the solderable material is a solder.

7. The electric connection element of claim 5, wherein the solderable material is tin.

8. The electric connection element of claim 1, wherein the electrically conductive coating contains an adhesive.

9. The electric connection element of claim 8, wherein the adhesive is a conductive adhesive.

10. The electric connection element of claim 1, wherein the electric conductor is made of metal or metal alloy.

11. The electric connection element of claim 1, wherein the electric conductor is made of copper.

12. The electric connection element of claim 1, wherein the electric conductor is made of copper alloy.

13. The electric connection element of claim 1, wherein the surface enlargement includes a knurling or fluting.

14. The electric connection element of claim 1, wherein the surface enlargement is made by a grinding process.

15. The electric connection element of claim 1, wherein the surface enlargement is made by an etching process.

16. The electric connection element of claim 1, wherein the surface enlargement extends in cross section only across a coating region that is intended for energy absorption.

17. The electric connection element of claim 1, wherein the surface enlargement extends in cross section over the entire circumference of the coating.

18. The electric connection element of claim 1, wherein the electric conductor is made from a punched part or a cut band.

19. The electric connection element of claim 1, wherein the electric conductor has a length dimension which is greater than a cross section.

20. The electric connection element of claim 1, wherein the electric conductor is designed in the form of a wire.

21. The electric connection element of claim 13, wherein the knurling or fluting extends in substantial parallel relationship to a length dimension of the electric conductor.

22. The electric connection element of claim 1, wherein the surface enlargement is made by a grinding process defined by a grinding direction which extends in substantial parallel relationship to a length dimension of the electric conductor.

23. The electric connection element of claim 1, wherein the electric conductor is circular in cross section.

24. The electric connection element of claim 1, wherein the electric conductor has a non-circular shape.

25. The electric connection element of claim 1, wherein the electric conductor is rectangular in cross section.

26. The electric connection element of claim 25, wherein the electric conductor designed as flat wire.

27. The electric connection element of claim 1, wherein the surface enlargement of the coating extends along an entire length of the electric conductor.

28. The electric connection element of claim 1, wherein the coating extends along an entire length of the electric conductor.

29. A solar cell on which an electric connection element according to claim 1 is applied.

30. A solar module, comprising at least two solar cells, and a connection element according to claim 1 for interconnecting the solar cells.

31. A method of contacting electric components, in particular solar cells, comprising the steps of:
coating an electric conductor with an electrically conductive coating;
enlarging a surface area of the coating, thereby producing an electric connection element; and
placing the electric connection element onto an electric component with the enlarged surface area facing the electric component to thereby enable the coating to establish a firm connection between the electric conductor and the electric component.

32. The method of claim 30, wherein the enlarging step includes the step of structuring the surface of the coating.

33. The method of claim 30, wherein the enlarging step includes the step of roughening the surface of the coating.

34. The method of claim 30, wherein the enlarging step includes the step of modifying a material of the coating itself to pattern the surface area.

35. The method of claim 30, wherein the electric conductor has a length dimension which is greater than a cross section thereof, said placing step including the step of placing the electric connection element along the length dimension onto the electric component.

36. The method of claim 30, wherein the electric is a wire.

37. The method of claim 30, wherein the electric is a flat wire.
